(19) United States
(12) Patent Application Publication
(10) Pub. No.: US 2009/0149591 A1
(43) Pub. Date: Jun. 11, 2009

(54) Paint Compositions With Low- or Zero-VOC Coalescence Aids and Nano-Particle Pigments

(76) Inventors: Yong Yang, Hillsborough, NJ (US); Robert Sheerin, N. Caldwell, NJ (US); Luz Clarena Shavel, Budd Lake, NJ (US)

Correspondence Address: THE H.T. THAN LAW GROUP, WATERFRONT CENTER SUITE 560, 1010 WISCONSIN AVENUE NW, WASHINGTON, DC, 20007, US

(21) Appl. No.: 11/952,622

(22) Filed: Dec. 7, 2007

(51) Int. Cl. C08K 3/22; C08K 3/34

(52) U.S. Cl. 524/418; 524/543; 524/425; 524/430; 524/433; 524/423; 524/432; 524/444; 524/456

(57) ABSTRACT

The invention is related to glossy, low- or zero-VOC aqueous paint compositions, comprising water based latex polymer, a hiding pigment, at least one low-VOC coalescence aid having a volatile organic content of less than 50 g/L, and a second inorganic pigment with particle size ranging from about 1 to 100 nanometers. The paint composition gives good block resistance and mechanical strength and can be adopted for paints with at least glossy and semi-gloss finishes.

### FIELD OF THE INVENTION

The present invention is directed to aqueous paint compositions, comprising water based latex polymer, at least one low or zero volatile organic compound coalescence aid, and an inorganic pigment with particle size less than 100 nanometers. The paint composition gives good block resistance and mechanical strength and can be adopted for paints with glossy and semi-gloss finishes.

### BACKGROUND OF THE INVENTION

To reduce volatile organic compounds (“VOC”) in latex paints for environmental and health reasons, several approaches can be used to provide low- or zero-VOC latex paints. However, less desirable properties are often associated with these paints. For example, reactive diluents can be used to replace traditional coalescence solvents. But high reactive diluents have short shelf-life and are not suitable for architectural paints, while low reactive diluents are not effective enough and have poor blocking resistance.

Self-crosslinking latex polymers can also be used for low-VOC and high gloss coatings. They have lower molecular weight range (100,000 to 200,000) than that of conventional latex polymers (500,000 to over a million), and lower minimum film forming temperature (“MFFT”) for better film formation. Although self-crosslinking monomers enhance the hardness of the dried films, the reactivity must be low enough to have reasonable shelf-life without losing the effectiveness of the self-crosslinking.

Stage-feed latex polymers can improve block resistance of aqueous paints as they comprise at least two polymer compositions with one having relatively high glass transition temperature (“T_{g}”) for blocking resistance and another having lower T_{g} for coalescence. Stage-feed latex polymers may reduce but not eliminate the amount of coalescence solvents required for low temperature coalescence in glossy paints.

The patent literature discloses a number of references relating to coating compositions with coalescent aid and other additives. However, there remains a need for low- or zero-VOC aqueous paint compositions having good block resistance and mechanical strength.

### BRIEF SUMMARY OF THE INVENTION

The present invention is directed to a latex paint composition, comprising a latex polymer, a first pigment preferably an inorganic pigment to provide hiding power to the paint, at least one low- or zero-VOC coalescence aid, and a second inorganic pigment. The composition according to the invention is suitable for all paints, preferably paints having high gloss or semi-gloss finish, and these paints have strong block resistance and strong mechanical strength. The low- or zero-VOC coalescence aid has a volatile organic content of less than about 50 g/L and a boiling of greater than about 220° C. The second inorganic pigment has a particle size ranging from about 1 to 100 nanometers and cooperate with the low- or zero-VOC coalescence aid to help the inventive paint maintain its gloss and to have desirable blocking property, hardness and resistance to water and moisture.

### DETAILED DESCRIPTION OF THE INVENTION

The invention is directed to aqueous latex paint compositions comprising a water-based latex polymer, a pigment that provides hiding power such as titanium dioxide, at least one low- or zero-VOC coalescence aid with a high boiling point, and a second inorganic pigment with particle size from about 1 to 100 nm. Hiding pigments include pigments, such as titanium dioxide or other white pigments, that hide the covered substrate, and color pigments that tint the paint. A suitable second pigment is colloidal silica particles made from a sol-gel process of sodium silicate. The latex paint composition of this invention is suitable for glossy, low- or zero-VOC paints with good blocking resistance, and mechanical strength.

“Low-VOC” compositions can have a VOC content of not more than about 150 g/L (about 15% w/v), preferably not more than about 100 g/L (about 10% w/v), more preferably not more than about 50 g/L (about 5% w/v), and most preferably less than 20 g/L, for example not more than about 10 g/L (about 1% w/v) or not more than about 8 g/L (about 0.8% w/v).

“Zero-VOC” compositions can also be part of this invention. Zero-VOC compositions can advantageously have a VOC content of not more than about 5 g/L (about 0.5% w/v), according to the EPA Method 24, for example not more than about 2 g/L (about 0.2% w/v) or not more than about 1 g/L (0.1% w/v). In addition, according to this invention, when zero-VOC compositions are formulated, no volatile organic solvents are added.

“Coalescence aids,” also known as “coalescents,” “coalescing agents” or “coalescing solvents,” are compounds that bring together polymeric components in latex paints to form films. Coalescence aids facilitate the formation of the dried film by temporarily plasticizing, i.e. softening, the latex polymers and subsequently evaporating from the dried film. They can be used, in conjunction with monomers that give rise to polymers of moderately harder characteristics or high T_{g} values, to make paints with sufficient resistance properties at low application temperature. However, odors derived from the evaporation of the volatile coalescence aids, such as 2,2,4-trimethyl-1,3-pentanediol monoisobutyrate (Texanol EA), are undesirable. But if volatile coalescence aids are to be avoided all together, paints for low temperature application must use predominantly monomers that give rise to polymers of relatively softer characteristics or low T_{g} values. The paints derived from latex using softer polymers show soft and tacky properties. Low- or zero-VOC coalescence aids are those compounds that enhance the polymers to form dried films without the accompanying odors.

Suitable low- or zero-VOC coalescence aids for use in the present invention include organic compounds with boiling points above about 220° C., preferably above about 250° C. and more preferably above about 270° C., and therefore do not evaporate or flash, i.e. non-volatile, at expected indoor and outdoor temperatures, and may not be detected by gas chromatogram (GC) using EPA Method 24 as defined below. Some of these low- or zero-VOC coalescence aids eventually form chemical bonds with polymers, and become a part of the polymer binder. These low- or zero-VOC coalescence aids work as plasticizers that soften the latex polymer particles for film formation. Unlike traditional coalescence solvents that evaporate from paints once they are dried, low- or zero-VOC coalescence aids stay in the dried paint films for an indefinite period of time, rendering the paint films soft and tacky for days or even for weeks. Therefore, due to their undesirable block resistance and weak mechanical properties, these low- or zero-VOC coalescence aids, if used without the modification as presented in this invention, have limited application to paints.

In accordance with one aspect of the present invention, low- or zero-VOC coalescence aids are combined with inorganic pigments, such as silica, having particle size in the range of about 1 to 100 nm. Such pigments complement the low- or zero-VOC coalescence aids by increasing the block resistance as well as the other mechanical properties of the film formed by the coating composition.

An example of low- or zero-VOC coalescence aids is Optifilm Enhancer 300, which is a low-VOC, low odor “green” coalescent for emulsion paints. See “Optifilm Enhancer 300, A Low Odor, Non-VOC, ‘Green’ Coalescent for Emulsion Paint,” Eastman Chemical Company, Publication M-AP315, April 2005. Optifilm Enhancer 300 can be applied to a variety of architectural coatings. With a boiling point of 281° C. and an empirical formula of C₁₆H₃₀O₄, it is a non-volatile organic compound that is particularly suitable for low odor flat and semi-gloss (including soft sheen, satin, vinyl silk and eggshell) interior wall paints. See “Eastman Coatings Film Technologies: Film Optimization for Architectural Coatings,” Eastman Chemical Company, 2005.

An example of zero-VOC coalescence aid is Optifilm Enhancer 400, which is a very low VOC, low odor coalescent that gives good film integrity, touch-up properties and scrub resistance. With a boiling point of 344° C., Optifilm Enhancer 400 is an alternate to ortho-phthalates such as butyl benzyl phthalate (BBP) and dibutyl phthalate (DBP) as plasticizers. See “Optifilm Enchancer 400—A Non-Phthalate Alternate,” Eastman Chemical Company, Publication TT-75, May 2006. Optifilm Enhancer 400 is able to reduce the MFFT of various latexes in a more efficient manner than BBP. Because Optifilm Enhancer 400 becomes an integral part of the paint film, it adds to the flexibility of the paint coating.

Another suitable zero-VOC coalescence aid is Archer Reactive Coalescent (Archer RC™), which is a propylene glycol monoester of unsaturated fatty acids derived from vegetable oils. Archer RC™ is found to be nonvolatile when tested by EPA Method 24, possibly due to the oxidation and subsequent crosslinking of its unsaturated component with the coating material.

A different example of zero-VOC coalescence is BASF Pluracoa™ CA 120 (ES8511). The Pluracoat™ brand additives are organic liquid based on proprietary technology from BASF. They contain zero-VOC and can be used as coalescent aid for low- or zero-VOC latex paints.

Additional conventional examples of low- or zero-VOC coalescing agents that may be used in the present invention include, but are not limited to, dicarboxylic/tricarboxylic esters, such as bis(2-ethylhexyl) phthalate (DEHP), diusononyl phthalate (DINP), bis(n-butyl)phthalate (DnBP, DBP), butyl benzyl phthalate (BBzP), diisodecyl phthalate (DIDP), di-n-octyl phthalate (DOP or DnOP), diisooctyl phthalate (DIOP), diethyl phthalate (DEP), diusobutyl phthalate (DIBP), di-n-hexyl phthalate, trimethyl trimellitate (TMTM), tri-(2-ethylhexyl) trimellitate (TEHTM-MG), tri-(n-octyl,n-decyl) trimellitate (ATM), tri-(heptyl,nonyl) trimellitate (LTM) and n-octyl trimellitate (OTM); adipates, such as bis(2-ethylhexyl)adipate (DEHA), dimethyl adipate (DMAD), monomethyl adipate (MMAD) and dioctyl adipate (DOA); sebacates, such as dibutyl sebacate (DBS); maleates such as dibutyl maleate (DBM) and diisobutyl maleate (DIBM). Other low- or zero-VOC coalescing agents include benzoates, epoxidized vegetable oils, such as N-ethyl toluene sulfonamide, N-(2-hydroxypropyl) benzene sulfonamide and N-(n-butyl) benzene sulfonamide; organophosphates, such as tricresyl phosphate (TCP) and tributyl phosphate (TBP), triethylene glycol dihexanoate, tetraethylene glycol diheptanoate, and polymeric plasticizers. Examples of commercial low- and zero-VOC coalescing agents are benzoate esters or alkyl benzoate esters, such as those sold under Benzoflex® and Velate®, and low molecular weight polyesters, such as those sold under Admex®.

The amounts of low- or zero-VOC coalescing agent(s) used for the latex of the invention may be in the range of about 1 g/L to 50 g/L (about 0.1 to 5.0 wt %) based on total wet paint, preferably from about 5 g/L to 40 g/L (about 0.5 to 4.0 wt %), more preferably from about 5 g/L to 40 g/L (about 0.5 to 3.0 wt %), most preferably from about 5 g/L to 20 g/L (about 0.5 to 2.0 wt %).

Pigments in paints serve the functions of presenting the desired coloration to be seen and blocking the undesired colors from being seen, i.e., providing tinting power and hiding power to the paint. Some paints use organic pigments such as phthalocyanin, Indian yellow, indigo, etc., while other paints use inorganic pigments such as cadmium pigments, cobalt pigments, etc.

Inorganic pigments suitable for the invention include titanium oxide in both the anastase and rutile forms, clay (aluminum silicate), calcium carbonate in both the ground and precipitated forms, aluminum oxide, silica (silicon dioxide), magnesium oxide, talc (magnesium silicate), barytes (barium sulfate), zinc oxide, zinc sulfite, sodium oxide, potassium oxide and the like. Titanium dioxide is commonly used to provide paints with hiding power. Additional examples of inorganic pigments can be found in U.S. Pat. No. 6,933,415, the disclosure in which is hereby incorporated by reference. Suitable organic and inorganic pigments are disclosed in co-pending patent application Ser. No. 11/470,817, which is incorporated herein by reference in its entirety.

“Nano-particles” are those microscopic particles that are described in nanometers. In general, “nano-sized” particles are those with all dimensions being less than about 100 nm, or preferably less than about 60 nm, more preferably less than about 30 nm or less than about 20 nm. Alternatively, the nano-sized particles, e.g., the second inorganic pigments described below, have a mean particle size in the range of about 1 to 100 nm, preferably less than about 50 nm, and more preferably less than about 30 nm or 20 nm. Furthermore, the hiding pigments in the composition can also be nano-sized.

In the present invention, it is discovered that a second pigment, preferably inorganic pigment smaller than about 100 nm, when added to the paint composition can complement the high boiling-point coalescence aids. Traditional inorganic pigments have dimensions ranging from a few hundred nanometers to over 10 micrometers, and they also have irregular shapes, which tend to reduce gloss. However, the inorganic pigments used in this invention are “nano-sized” and they are more spherical in shape than those of the conventional pigments. These unique features of the nano-sized pigments provide paints with high gloss finishes at relatively high pigment contents. The nano-sized pigments also have highly reactive surfaces, and may pack tightly or even bond to polymers, thus enhancing the mechanical strength of dried films. The substantially uniform size of the pigments provides a higher gloss to the film.

One preferred example of inorganic pigment can be colloidal silica particles, made from sol-gel process of sodium silicate, such as Ludox®, commercially available from Grace/Davision Located in Columbia, Md., and Snowtex® from Nissan Chemical America Corporation in Houston. Colloidal silica particles are discrete uniform particles of silica which have no internal surface area or detectable crystal structure. These particles are dispersed in aqueous media ranging from neutral pH to alkaline pH from 8.5 to 10 as clear or translucent liquids. As negatively charged particles, they will repel each other and form a stable product. The applications of colloidal silica particles such as Ludox® include high temperature binder, inorganic coatings, antislip for flooring and polishes, and reinforcement agents for latex coatings.

Different grades of commercially available Ludox® that are suitable for this invention include Ludox® AM-30, Ludox® AS-30, Ludox® AS-40, Ludox® CL, Ludox® CL-X, Ludox® HS-30, Ludox® HS-40, Ludox® LS, Ludox® SM-30, Ludox® TM-40, Ludox® TM-50, and Ludox® TMA from Sigma-Aldrich Co. The preferred grades for the invention are Ludox® AS-30 and Ludox® HS-40. Grades of commercial available Snowtex® includes Snowtex® ST-20L, ST-4, ST-50, ST-C, ST-N, ST-O, ST-OL, ST-ZL, ST-PS-M, ST-PS-MO, ST-PS-S, and ST-PS-SO.

In the absence of nano-sized inorganic pigments, the use of low-VOC coalescence aid result in paint films that are tacky and have poor block resistance at room temperature and at 120° F. (49° C.) as discussed above. However, in the presence of nano-sized inorganic pigments, the use of low-VOC coalescence aid give rise to high gloss and semi gloss paints that pass the block resistance tests at room temperature and at 120° F. (49° C.).

In accordance with another aspect of the present invention, a ratio of the second pigment, e.g. colloidal silica, to low-/non-VOC coalescent aid should be in the range of about 0.5 to about 10, preferably in the range of about 1.0 to about 8.0, more preferably in the range of about 2.0 to about 6.0. As shown in the examples below, these ranges help the dried paint film retain its gloss or sheen.

Furthermore, a ratio of low-/non-VOC coalescent aid to binder (dried) by weight should be between about 0.005 and about 0.15, preferably from about 0.025 to about 0.12 and more preferably from about 0.050 to about 0.10.

As one variation of this invention, the aqueous latex paint compositions comprise multiple types of low- or zero-VOC coalescence aids and one type of inorganic pigments such as colloidal silica with particle sizes ranging from about 1 to 100 nm. The use of two or more coalescence aids result in high gloss paints that possess properties as desirable as with the use of one coalescence aid.

As another variation of this invention, the aqueous latex paint compositions comprise multiple types of low- or zero-VOC coalescence aids and multiple types of inorganic pigments such as colloidal silica with particle sizes less than 100 nm. The use of two or more types of coalescence aids in the presence of multiple types of inorganic pigments with particle sizes ranging from about 1 to 100 nm result in high gloss paints and thus add to the versatility of high gloss low- or zero-VOC paints.

The types of finishes of the paints using the latex of the invention can be high gloss, semi-gloss, satin or “silk”, eggshell, or flat. The degree of shininess, or gloss, is determined by the amount of pigment present in the paint. Without any pigment, most binders will yield a high gloss finish. Gloss or sheen can be measured in reflectivity of the painted surface at angles of 20°, 60°, and 85° from the vertical position in accordance with ASTM D-523. Gloss or sheen can also be represented by the pigment volume concentration (PVC) or amount of pigment in the paint composition, i.e., PVC=(pigment/pigment+binder).

TABLE 1
The Reflectivity of Paints with Different Gloss At Different Angles

| Type of Paint Finish | 20° Gloss | 60° Gloss | 80° Gloss | PVC |
|---|---|---|---|---|
| High Gloss | 20-90 | 70-95 | — | 15% |
| Semi-Gloss | 15-45 | 35-70 | — | 25% |
| Satin | — | 15-35 | 10-40 | 35% |

Examples of dispersants useful in the compositions according to the invention can include, but are not limited to, 2-amino-2-methyl-1-propanol, hydrophobic copolymers such as Tamol™ 165A, and combinations thereof

Examples of preservatives or biocides useful in the compositions according to the invention can include, but are not limited to, hydroxy-functional aza-dioxabicyclo compounds such as those commercially available from ISP under the tradename Nuosept™ 95.

Examples of defoamers useful in the paint compositions according to the invention can include, but are not limited to, polysiloxane-polyether copolymers such as those sold by Tego under the tradename Foamex™, those sold under the tradename BYK™, those sold under the tradename Drewplus™, those sold under the tradename Surfynol™, and the like, and combinations thereof

Examples of anticorrosive agents useful in the paint compositions according to the invention can include, but are not limited to, sodium nitrite and the like.

Examples of rheology modifiers useful in the paint compositions according to the invention can include, but are not limited to, those commercially available from Rohm & Haas under the tradename Acrysol™, such as RM-2020 NPR and RM-825.

While typically multiple pigments/colorants are present in end-use latexes that are to be used in paint or architectural coating applications, sometimes only a white pigment, such as a zinc oxide and/or a titanium oxide, is added in the early stages of the formation of the paint composition (e.g., in the base composition). In such a case, any other desired pigments/colorants of various colors (including more white pigment) can optionally be added at the later stages of, or after, formation of the paint composition.

Examples of pigments/colorants useful according to the invention can include, but are not limited to, carbon black, iron oxide black, iron oxide yellow, iron oxide red, iron oxide brown, organic red pigments, including quinacridone red and metallized and non-metallized azo reds (e.g., lithols, lithol rubine, toluidine red, naphthol red), phthalocyanine blue, phthalocyanine green, mono- or di-arylide yellow, benzimidazolone yellow, heterocyclic yellow, DAN orange, quinacridone magenta, quinacridone violet, and the like, and any combination thereof These exemplary color pigments can be added as powders, but can more conveniently be added as aqueous dispersions to paint compositions according to the invention.

Additionally, extender pigments/colorants can be added, e.g., to the grind composition portion of the paint composition. Examples of extender pigments/colorants useful in the paint compositions according to the invention can include, but are not limited to, silica, silicates, carbonates such as calcium carbonates, and the like, and combinations thereof.

The paint compositions according to the invention can exhibit a wide range of viscosities, depending upon the application. In one embodiment, the viscosity of the sequentially polymerized latex can be from about 65 to about 130 Krebunits (KU), preferably from about 70 to about 110 KU, more preferably from about 75 to about 105 KU. While coalescence, degradation, and other factors can cause the viscosity to increase over time, it is preferable that the viscosity not increase beyond about 130 KU, preferably not beyond about 120 KU, more preferably not beyond about 115 KU, and in some cases not beyond about 110 KU.

The latex polymer particles according to the invention can advantageously exhibit a pH from about 6 to about 10, although the pH needs only to be sufficient to maintain the stability of the particular latex and/or paint composition in combination with the surfactant(s) and other stabilizing components.

In one variation of the invention, the latex paint composition comprises sequentially polymerized latex particles that can be formulated according to the following method. First, a pigment dispersion composition, or grind, is formed by: combining water, a dispersant, a pH adjustor, a surfactant, a defoamer, a colorant/pigment, and a biocide/preservative; stirring and optionally grinding for a period of time to sufficiently mix the ingredients; and, while continuing to stir and/or grind, adding more water. To this pigment dispersion composition can be added a latex containing sequentially polymerized polymer particle according to the invention, followed by a pH adjustor, if desired, and a performance additive composition comprising an organic solvent, a surfactant, and a defoamer. Optionally but preferably, an anticorrosive solution can then be added. Then, a rheology modifier can be added, optionally including more water, if desired, and also a pH adjustor, thus forming a paint composition. Furthermore, if desired, more colorant(s) and/or pigment(s) can be added to the paint composition either to compliment the (white) pigment(s)/colorant(s) already in the pigment dispersion composition or to add another desired color to the paint composition. A coalescence solvent may optionally be added later.

### EXAMPLES

The following examples are only illustrative of certain embodiments of the invention and contain comparisons of compositions and methods according to the invention with the prior art and/or embodiments not according to the invention. The following examples are not meant to limit the scope and breadth of the present invention, as recited in the appended claims. In these examples, about 52 lbs of titanium dioxide pigment (silica/alumina treated rutile TiO₂ pigment) is combined with about 500 lbs of acrylic latex (Rhoplex SG-10M from Rohm and Haas). In comparative examples 1 and 2, a low VOC coalescence aid and water were added to the paint compositions without a second inorganic nano-sized pigment. A small amount of calcium carbonate was added to example 2. In inventive examples 3, 4 and 5, about 200 lbs of a nano-sized colloidal silica were added to the paint compositions. In inventive examples 6, about 240 lbs of another type of nano-sized colloidal silica were added.

Table 2 listed paints using this invention in comparison to paints with conventional technology these are deep base paints which usually have worse blocking resistance than pastel and medium bases.

### Example 1

### A Comparative Paint Having Zero-VOC Coalescence Aid

Example 1 was a comparative paint with Optifilm Enhancer 400, a zero-VOC coalescence aid. The gloss was 81 at 60°. Example 1 failed the blocking resistance test using ASTM D4946 by showing 100% of area removed at both room temperature and 120° F. Example 1 was not only tacky but also soft for days and even weeks after the paint was dried.

A pencil hardness test was conducted according to ASTM D3363 using a BYK Pencil Hardness tester on these examples. A set of pencils having a range of pencil leads from 9B (softest) to 9H (hardest) with softness to hardness in the following order 9B, 8B, 7B, 6B, 5B, 4B, 3B, 2B, B, HB, 1H, 2H, 3H, 4H, 5H, 6H, 7H, 8H, 9H were pressed against dried paint samples, e.g., in the order from soft to hard or simultaneously. The first pencil in the soft to hard continuum that leaves a mark provides the hardness value for that dried paint. The pencil hardness tests were conducted on 3-mil draw-downs on Lenetta Draw Down Charts. The dried film formed from example 1 can withstand a pencil harness test value equivalent to a 3B pencil lead.

A water sensitivity test was also conducted. Three drops of water were placed on dried 3-mil draw-down samples for one minute. The water was wiped off and the water spot was scratched with a finger nail to check the hardness of the film. A rating of 1 to 5 is assigned, where
1=soft and scratched off easy;
2=soft and scratched off with some force;
3=medium soft and scratch some portions off with force;
4=hard and scratch slightly off with strong force; and
5=hard and can't scratch off.
   The dried film formed from example 1 exhibits a water sensitivity value of 1.

### Example 2

### A Comparative Paint Having Zero-VOC Coalescence Aid and Traditional Pigment

Example 2 was a comparative paint with Optifilm Enhancer 400 having Omyocarb 3, which is a traditional calcium carbonate pigment. Example 2 showed a significant reduction of gloss to 60 at 60° with only about 1.2 wt % of calcium carbonate. Example 2 also failed the blocking resistance test by showing 100% of area removed at both room temperature and 120° F. Example 2 was not only tacky but also soft for days and even weeks after the paint was dried. Example 2 has a pencil hardness value of 3B and a water sensitivity of 1.

### Example 3

### First Inventive Sample of Paint Having Zero-VOC Coalescence Aid and Nano-Sized Inorganic Pigment

Example 3 was a paint using Optifilm Enhancer 400 as the zero-VOC coalescence aid, and Ludox® AS-30 as the nano-sized inorganic pigment. Example 3 was prepared using 200 lbs of Ludox® AS-30, resulting in about 60 lbs of dried silica nano-particles in a 100-gallon batch. The particle size of Ludox® AS-30 is about 12 nm. The gloss of Example 3 was 80 at 60°, almost identical to that of Example 1. Example 3 passed the test for block resistance by showing 0% of area removed at room temperature and only 20% of area removed at 120° F. Example 3 has a pencil hardness value of >9H and a water sensitivity of 4. Example 3 dried to a harder film than those of Examples 1 and 2, indicating stronger mechanical strength during the same duration of observation. In addition, Example 3 showed significant improvement of water-resistance.

### EXAMPLE 4

### Second Inventive Sample

Example 4 was a paint using BASF CA 120 (ES 8511) as the zero-VOC coalescence aid, and Ludox® AS-30 as the nano-sized inorganic pigment. The gloss of Example 4 was 79 at 60°. Example 4 passed the test for block resistance by having 0% of area removed at room temperature and only 30% of area removed at 120° F. Example 4 has a pencil hardness value of >9H and a water sensitivity of 4, similar to inventive example 3. Dried paint of Example 4 is also harder than those of Examples 1 and 2, demonstrating stronger mechanical strength for the same duration of observation.

### Example 5

### Third Inventive Sample

Example 5 was a paint using Archer RC™ as the zero-VOC coalescence aid, and Ludox® R AS-30 as the nano-sized inorganic pigment. The gloss of Example 5 was 67 at 60°. Example 5 passed the test for block resistance by having 0% of area removed at room temperature and only 50% of area removed at 120° F. Example 5 has a pencil hardness value of >9H and a water sensitivity of 4, similar to inventive examples 3 and 4. Dried paint film of Example 5 is harder as compared to those of Examples 1 and 2 for the same duration of observation.

### Example 6

### Fourth Inventive Sample

Example 6 was a paint using Optifilm Enhancer 400 as the zero-VOC coalescence aid, and Ludox® HS-40 as the nano-sized inorganic pigment. Example 6 contained about 96 lbs (240 lbs at 40% solids) of dried silica nanoparticles and still showed reasonably high gloss for semi-gloss paints. The gloss of Example 6 was 69 at 60°. Example 6 passed the test for block resistance by having 0% of area removed at both room temperature and 120° F. Example 6 has a pencil hardness value of >9H and a water sensitivity of 5, which is higher than the water sensitivity of inventive examples 3, 4, and 5. Example 6 also demonstrated much stronger mechanical strength than Examples 1 and 2 for the same duration of observation.

TABLE 2
Examples (in lbs) of Zero and Low VOC high and semi-gloss paints

| | Example 1 | Example 2 | Example 3 | Example 4 | Example 5 | Example 6 |
|---|---|---|---|---|---|---|
| WATER | 40 | 40 | 40 | 40 | 40 | 20 |
| HASE¹ | 2 | 2 | 2 | 2 | 2 | 2 |
| 29% aqueous | 1 | 1 | 1 | 1 | 1 | 1 |
| ammonium | | | | | | |
| hydroxide pH | | | | | | |
| adjuster (AMM | | | | | | |
| 26 BE) | | | | | | |
| Hydrophobic | 6.5 | 6.5 | 6.5 | 6.5 | 6.5 | 6.5 |
| Dispersant | | | | | | |
| (TAMOL | | | | | | |
| 165A,) | | | | | | |
| Low Foam | 0.65 | 0.65 | 0.65 | 0.65 | 0.65 | 0.65 |
| Surfactant | | | | | | |
| (TRITON CF- | | | | | | |
| 10) | | | | | | |
| Rutile TiO₂ | 52 | 52 | 52 | 52 | 52 | 52 |
| Pigment | | | | | | |
| (TRONOX CR- | | | | | | |
| 826) | | | | | | |
| Calcium | 0 | 10 | 0 | 0 | 0 | 0 |
| Carbonate | | | | | | |
| Pigment | | | | | | |
| (Omyocarb 3) | | | | | | |
| Defoamer | 0.5 | 0.5 | 0.5 | 0.5 | 0.5 | 0.5 |
| (Foamaster A- | | | | | | |
| 40) | | | | | | |
| Microbicide | 1.1 | 1.1 | 1.1 | 1.1 | 1.1 | 1.1 |
| (Kathon LX | | | | | | |
| 1.5%) | | | | | | |
| | Grind at 2000 rpm for 10 min. | | | | | |
| Paste from | 103.75 | 113.75 | 103.75 | 103.75 | 103.75 | 83.75 |
| above | | | | | | |
| Non-Ionic | 6.6 | 6.6 | 6.6 | 6.6 | 6.6 | 6.6 |
| Surfactant | | | | | | |
| (Triton X-100) | | | | | | |
| Surfactant | 1.15 | 1.15 | 1.15 | 1.15 | 1.15 | 1.15 |
| (Aerosol OT | | | | | | |
| 75%) | | | | | | |
| Acrylic Latex, | 500 | 500 | 500 | 500 | 500 | 500 |
| Rhoplex ® (SG- | | | | | | |
| 10M) | | | | | | |
| Low-VOC | 18 | 18 | 18 | 0 | 0 | 18 |
| Coalescence | | | | | | |
| Aid OP | | | | | | |
| Enhancer 400 | | | | | | |
| Low-VOC | 0 | 0 | 0 | 18 | 0 | 0 |
| Coalescence | | | | | | |
| Aid BASF 8511 | | | | | | |
| Propylene | 0 | 0 | 0 | 0 | 18 | 0 |
| glycol | | | | | | |
| monoester of | | | | | | |
| unsaturated fatty | | | | | | |
| acid (Archer | | | | | | |
| RC) | | | | | | |
| NH₄OH (conc.) | 0.78 | 0.78 | 0.78 | 0.78 | 0.78 | 0.78 |
| Colloidal Silica | 0 | 0 | 200 | 200 | 200 | 0 |
| Ludox AS-30 | | | | | | |
| (30%) | | | | | | |
| Colloidal Silica | 0 | 0 | 0 | 0 | 0 | 240 |
| Ludox HS-40 | | | | | | |
| (40%) | | | | | | |
| Rheology | 20 | 20 | 20 | 20 | 20 | 20 |
| Modifier | | | | | | |
| (ACRYSOL | | | | | | |
| RM5000) | | | | | | |
| Rheology | 5.7 | 5.7 | 1 | 1 | 1 | 1 |
| Modifier/Non- | | | | | | |
| Ionic RM825 | | | | | | |
| Water | 140 | 98 | 0 | 0 | 0 | 0 |
| Defoamer (BYK | 2 | 6 | 2 | 2 | 2 | 2.2 |
| 022) | | | | | | |
| Defoamer (A40) | 0 | 0.7 | 0 | 0 | 0 | 0 |
| Gloss (60°) | 81 | 60 | 80 | 79 | 67 | 69 |
| Block (RT)² | 100% | 100% | 0% | 0% | 0% | 0% |
| Block (120° F.)³ | 100% | 100% | 20% | 30% | 50% | 0% |
| Pencil Hardness | 3B | 3B | >9H | >9H | >9H | >9H |
| Test | | | | | | |
| Water | 1 | 1 | 4 | 4 | 4 | 5 |
| sensitivity Test | | | | | | |

¹HASE: hydrophobically modified alkali soluble emulsion (30%)
²Blocking test: Percent of area removed at room temperature
³Blocking test: Percent of area removed at 120° F. for paint dried overnight

Block resistance, or the propensity of a coating to adhere to itself instead of to its substrate, was measured according to a modified version of ASTM D4946. On a sealed white Leneta™ WK card, three 9″-wide draw down coatings of samples of about 3 mils thickness were prepared side by side and allowed to cure for about 1 week at room temperature (e.g., from about 20-25° C.). After curing, each of the three draw down coating samples was cut into four 1″ squares. Two of these squares were oriented face to face (i.e., coated sides touching) and are placed under a 100-gram weight in a 120° F. oven for about 24 hours. The other two of these squares were oriented face to face and placed under a 100-gram weight at room temperature for about 24 hours. Both sets of face to face squares were then allowed to equilibrate to ambient temperature for about ½ hour. Each set of squares was then pulled apart using a slow and steady force, forming a T pattern. Block resistance was rated based on the percentage of area of the paint on one surface that was transferred to the other surface. 0% transfer indicates a perfect blocking resistance while 100% transfer indicated paints on both sides are completely stuck together.

While various embodiments of the present invention have been described above, it should be understood that they have been presented by way of illustration and example only, and not limitation. It will be apparent to persons skilled in the relevant art that various changes in form and detail can be made therein without departing from the spirit and scope of the invention. Thus, the breadth and scope of the present invention should not be limited by any of the above-described exemplary embodiments, but should be defined only in accordance with the appended claims and their equivalents. It will also be understood that each feature of each embodiment discussed herein, and of each reference cited herein, can be used in combination with the features of any other embodiment. All patents and publications discussed herein are incorporated by reference herein in their entirety.

1. A latex paint composition comprising a latex polymer, a first pigment to provide hiding power a dried film formed by the latex paint composition, at least one coalescence aid, and a second pigment,
wherein the total pigment to binder concentration (PVC) ratio of the latex paint composition is less than about 35%,
wherein the coalescence aid has a boiling point of greater than about 220° C.,
wherein the second pigment is an inorganic pigment measured in all dimensions less than about 100 nm, such that the second pigment has substantially no effect on the gloss of said dried film, and
wherein a ratio of the second pigment to coalescence aid is from about 0.5 to about 10.0.

2. The latex paint composition of claim 1, wherein the second inorganic pigment comprises colloidal silica.

3. The latex paint composition of claim 1, wherein said at least one coalescence aid has a boiling point of greater than about 250° C.

4. The latex paint composition of claim 3, wherein said at least one coalescence aid has a boiling point of greater than about 270° C.

5. The latex paint composition of claim 1, wherein said at least one coalescence aid is selected from a group consisting of carboxylic/tricarboxylic esters, bis(2-ethylhexyl) phthalate (DEHP), diisononyl phthalate (DINP), bis(n-butyl)phthalate (DnBP, DBP), butyl benzyl phthalate (BBzP), diisodecyl phthalate (DIDP), di-n-octyl phthalate (DOP or DnOP), diisooctyl phthalate (DIOP), diethyl phthalate (DEP), diisobutyl phthalate (DIBP), di-n-hexyl phthalate, trimethyl trimellitate (TMTM), tri-(2-ethylhexyl) trimellitate (TEHTM-MG), tri-(n-octyl,n-decyl) trimellitate (ATM), tri-(heptyl,nonyl) trimellitate (LTM), n-octyl trimellitate (OTM), adipates, bis(2-ethylhexyl)adipate (DEHA), dimethyl adipate (DMAD), monomethyl adipate (MMAD) and dioctyl adipate (DOA), sebacates, dibutyl sebacate (DBS), maleates, dibutyl maleate (DBM), diisobutyl maleate (DIBM), benzoates, epoxidized vegetable oils, N-ethyl toluene sulfonamide, N-(2-hydroxypropyl) benzene sulfonamide and N-(n-butyl) benzene sulfonamide, organophosphates, tricresyl phosphate (TCP) and tributyl phosphate (TBP), triethylene glycol dihexanoate, tetraethylene glycol diheptanoate, polymeric plasticizers, benzoate esters, alkyl benzoate esters, and low molecular weight polyesters.

6. The latex paint composition of claim 1, wherein said at least one coalescence aid, has a volatile organic content of less then 50 g/L.

7. The latex paint composition of claim 6, wherein said at least one coalescence aid has a volatile organic content of less than 20 g/L.

8. The latex paint composition of claim 7, wherein said at least one coalescence aid has a volatile organic content of less than 5 g/L.

9. The latex paint composition of claim 8, wherein the second inorganic pigment measured in all dimensions less than about 60 nm.

10. The latex paint composition of claim 9, wherein the second inorganic pigment measured in all dimensions less than about 30 nm.

11. The latex paint composition of claim 10, wherein the second inorganic pigment measured in all dimensions less than about 20 nm.

12. The latex paint composition of claim 1, wherein the second inorganic pigment is a member selected from the group consisting of aluminum silicate, calcium carbonate, aluminum oxide, silicon dioxide, magnesium oxide, magnesium silicate, barium sulfate, zinc oxide, zinc sulfite, sodium oxide, and potassium oxide.

13. The latex paint composition of claim 1, wherein the first pigment comprises titanium dioxide.

14. The latex paint composition of claim 1, wherein the coalescence aid forms a part of said dried film.

15. The latex paint composition of claim 1, wherein said dried film has a gloss of at least 35 at 60°.

16. The latex paint composition of claim 15, wherein said dried film has a gloss of at least 70 at 60°.

17. The latex paint composition of claim 1, wherein said dried film has a pencil hardness value of at least 9H.

18. The latex paint composition of claim 1, wherein said dried film has a water sensitivity value of at least 4.

19. The latex paint composition of claim 18, wherein said dried film as a water sensitivity value of at least 5.

20. The latex paint composition of claim 1, wherein the PVC is less than about 25%.

21. The latex paint composition of claim 20, wherein the PVC is less than about 15%.

22. The latex paint composition of claim 1, wherein said dried film has a block resistance of about 0% at room temperature.

23. The latex paint composition of claim 1, wherein said dried film has a block resistance of less than about 50% at 120° F.

24. The latex paint composition of claim 23, wherein said dried film has a block resistance of less than about 30% at 120° F.

25. The latex paint composition of claim 24, wherein said dried film has a block resistance of less than about 30% at 120° F.

26. The latex paint composition of claim 25, wherein said dried film has a block resistance of less than about 20% at 120° F.

27. The latex paint composition of claim 1, wherein a ratio of the second pigment to coalescence aid is from about 1.0 to about 8.0.

28. The latex paint composition of claim 27, wherein a ratio of the second pigment to coalescence aid is from about 2.0 to about 6.0.

29. The latex paint composition of claim 1, wherein a ratio of the coalescence aid to latex polymer is from about 0.005 to about 0.15.

30. The latex paint composition of claim 29, wherein a ratio of the coalescence aid to latex polymer is from about 0.025 to about 0.12.

31. The latex paint composition of claim 30, wherein a ratio of the coalescence aid to latex polymer is from about 0.050 to about 0.10.
